(19) United States
(12) Patent Application Publication
(10) Pub. No.: US 2026/0242651 A1
(43) Pub. Date: Aug. 20, 2026

(54) COMPOSITION AND METHOD FOR PREPARING MICROENCAPSULATED PHASE CHANGE MATERIALS

(71) Applicant: Dow Global Technologies LLC, Midland, MI (US)

(72) Inventors: Minbiao Hu, Shanghai (CN); Liang Zhang, Shanghai (CN); Jiguang Zhang, Shanghai (CN); Wei Li, Shanghai (CN)

(73) Assignee: Dow Global Technologies LLC, Midland, MI (US)

(21) Appl. No.: 18/695,505

(22) PCT Filed: Oct. 28, 2023
(86) PCT No.: PCT/CN2021/127007

§ 371 Date: Mar. 26, 2024

(51) Int. Cl. C09K 5/06

(52) U.S. Cl. CPC C09K 5/063

(57) ABSTRACT

The present disclosure relates to a composition and method for preparing microencapsulated phase change materials. The composition comprises oil phase a component and a water phase component; (1) the oil phase component comprises, based on the total weight of the oil phase component: —from 40 wt % to 99 wt % of phase change materials; —from 0.5 wt % to 30 wt % of aliphatic isocyanates having at least two NCO-functional groups; and —from 0.5 wt % to 30 wt % of aromatic isocyanates having at least two NCO-functional groups; (2) the water phase component comprises: —water in amount of at least 3 times the total weight of the oil phase component and —water soluble amine compounds having at least two NH-functional groups, wherein the mole ratio of NH— to NCO— is from 0.5:1 to 3:1. The method is a robust and efficient process, which does not require any organic solvents or surfactants.

### FIELD

The present disclosure relates to a composition and method for preparing microencapsulated phase change materials. The method is a robust and efficient process, which does not require any solvents or surfactants.

### BACKGROUND

Phase change materials (PCMs) have been widely studied and used in different kinds of applications. In building systems, a lot of works have proved the performance of PCMs to reduce the energy consumption. Solid-liquid PCMs are the most popularly used materials and widely studied. As the solid-liquid PCMs will melt after they absorb heat, it is necessary to encapsulate them before applied in building constructions to prevent leakage. Generally, PCMs can be stabilized with the methods of impregnation, marco-encapsulation and micro-encapsulation. The two main characteristics are their stabilization and heat transfer rate. A well encapsulated PCM shall have excellent stabilization and high heat transfer rate.

The impregnation method is to use a porous matrix to absorb PCMs. Leakage is still its risk during melting and solidification cycles. Usually, organic PCMs show a lower thermal conductivity. Therefore, the heat transfer rate of the impregnated materials highly depends on the thermal conductivity of the matrix framework. Macro-encapsulation (>1 mm) is also a simple and cheap method. However, the heat transfer rate is usually low. A simulation work revealed that it would take 169.2 min to melt a 50 mm macrocapsule of wax. The core part may remain solid, whereas, the edge part has melted to the liquid form, thus preventing the effective heat transfer. Micro-encapsulation (1-1000 μm) has been proved as an effective method to get a high heat transfer rate because of its high surface area. According to the simulation, only 2.2 seconds were needed if the diameter of capsule was 500 μm.

Different kinds of encapsulation methods were developed in the last several decades to prepare PCM microcapsules. In-situ polymerization, interfacial polymerization and emulsion polymerization are the three main methods. During interfacial polymerization, organic PCMs together with isocyanates are emulsified by surfactants in an aqueous phase. Sometimes solvent is added in the oil phase. Hardeners, like alcohol or amine, are added slowly to react with NCO groups to get a polyurea or polyurethane shell.

However, the interfacial polymerization requires carefully controlled polymerization parameters, e.g. stirring speed and hardener addition speed. Moreover, the use of solvents is often required because the phase change materials usually are immiscible with the reactive aromatic isocyanates which react preferentially quickly to form a stable shell. Solvent may also be added to help the dissolving of other isocyanates in organic PCMs. For regulatory, environmental, and process efficiency reasons, solvents are disfavored. Another critical and less obvious reason to remove solvents is considerations of the wastewater treatment if the system has to be filtered to recover microcapsule powders. A reactor system that does not contain such solvents, allows for both the easy separation of the encapsulated material as well as easy recycling of the reactor effluent water. Aqueous surfactants or colloidal stabilizers may be disfavored in a process that recycles the reactor effluent because the concentration would need to be monitored and corrected for to ensure the microcapsules maintain the desired particle size.

Hence there is still an urgent request for unique method for preparing microencapsulated phase change materials which can overcome the shortcomings as stated above and meet all requirements on PCM microcapsules, environmental regulations and process efficiency.

After persistent exploration, we have surprisingly developed a unique composition for preparing microencapsulated phase change materials by using a particularly designed formulation which can solve the above said shortcomings in manufacturing PCM microcapsules.

### SUMMARY

The present disclosure provides a unique composition for preparing microencapsulated phase change materials, and a method for preparing microencapsulated phase change materials using the composition.

In a first aspect of the present disclosure, the present disclosure provides a composition for preparing microencapsulated phase change materials, wherein the composition comprises an oil phase component and a water phase component;
(1) the oil phase component comprises, based on the total weight of the oil phase component:
   from 40 wt % to 99 wt % of phase change materials;
   from 0.5 wt % to 30 wt % of aliphatic isocyanates having at least two NCO-functional groups; and
   from 0.5 wt % to 30 wt % of aromatic isocyanates having at least two NCO-functional groups;
(2) the water phase component comprises:
   water in amount of at least 3 times the total weight of the oil phase component, and
   water soluble amine compounds having at least two NH-functional groups, wherein the mole ratio of NH— to NCO— is from 0.5:1 to 3:1.

In a second aspect of the present disclosure, the present disclosure provides a composition for preparing microencapsulated phase change materials, wherein the oil phase component further comprises, based on the total weight of the oil phase component, from 5 wt % to 25 wt % of inorganic fillers.

In a third aspect of the present disclosure, the present disclosure provides a method for preparing microencapsulated phase change materials comprising:
(1) blending a mixture of aliphatic isocyanates having at least two NCO-functional groups and aromatic isocyanates having at least two NCO-functional groups with phase change materials, to form an oil phase component, and the oil phase component comprises, based on the total weight of the oil phase component:
   from 40 wt % to 99 wt % of phase change materials;
   from 0.5 wt % to 30 wt % of aliphatic isocyanates having at least two NCO-functional groups; and
   from 0.5 wt % to 30 wt % of aromatic isocyanates having at least two NCO-functional groups;
(2) dissolving amine compounds having at least two NH-functional groups in water to form a water phase component and the water phase component comprises:
   water in amount of at least 3 times the total weight of the oil phase component, and
   water soluble amine compounds having at least two NH-functional groups, wherein the mole ratio of NH— to NCO— is from 0.5:1 to 3:1; and
(3) under stirring, adding the oil phase component into the water phase component to form microencapsulated phase change materials.

It is to be understood that both the foregoing general description and the following detailed description are exemplary and explanatory only and are not restrictive of the invention, as claimed.

### BRIEF DESCRIPTION OF THE DRAWINGS

FIG. 1 is optical microscope pictures of comparative examples in the present disclosure.

FIG. 2 is optical microscope pictures of inventive examples in the present disclosure.

FIG. 3 is optical microscope picture at the room temperature (a), polarized microscope picture at the room temperature (b), and polarized microscope picture at 50° C. (c) of inventive example 1 in the present disclosure.

FIG. 4 is 20 solidification-melting cycles DSC curves in the present disclosure.

### DETAILED DESCRIPTION OF THE INVENTION

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

As disclosed herein, “and/or” means “and, or as an alternative” or “additionally or alternatively”. All ranges include endpoints unless otherwise indicated.

In an embodiment of the present disclosure, the composition for preparing microencapsulated phase change materials comprises oil phase component and water phase component (i.e., two-component system). The oil phase component comprises, based on the total weight of the oil phase component, from 40 wt % to 99 wt %, from 40 wt % to 90 wt %, from 40 wt % to 80 wt %, from 40 wt % to 70 wt %, from 40 wt % to 60 wt %, from 40 wt % to 50 wt %, from 50 wt % to 99 wt %, from 50 wt % to 90 wt %, from 50 wt % to 80 wt %, from 50 wt % to 70 wt %, from 50 wt % to 60 wt %, from 60 wt % to 99 wt %, from 60 wt % to 90 wt %, from 60 wt % to 80 wt %, from 60 wt % to 70 wt %, from 70 wt % to 99 wt %, from 470 wt % to 90 wt %, from 70 wt % to 80 wt %, from 80 wt % to 99 wt %, from 80 wt % to 90 wt % or from 90 wt % to 99 wt % of phase change materials. The oil phase component comprises, based on the total weight of the oil phase component, from 0.5 wt % to 30 wt %, from 0.5 wt % to 25 wt %, from 0.5 wt % to 20 wt %, from 0.5 wt % to 15 wt %, from 0.5 wt % to 10 wt %, from 0.5 wt % to 5 wt %, from 5 wt % to 30 wt %, from 5 wt % to 25 wt %, from 5 wt % to 20 wt %, from 5 wt % to 15 wt %, from 5 wt % to 10 wt %, from 10 wt % to 30 wt %, from 10 wt % to 25 wt %, from 1.0 wt % to 20 wt %, from 1.0 wt % to 15 wt %, from 15 wt % to 30 wt %, from 15 wt % to 25 wt %, from 15 wt % to 20 wt %, from 20 wt % to 30 wt %, from 20 wt % to 25 wt % or from 25 wt % to 30 wt % of aliphatic isocyanates having at least two NCO-functional groups. The oil phase component comprises, based on the total weight of the oil phase component, from 0.5 wt % to 30 wt %, from 0.5 wt % to 25 wt %, from 0.5 wt % to 20 wt %, from 0.5 wt % to 15 wt %, from 0.5 wt % to 10 wt %, from 0.5 wt % to 5 wt %, from 5 wt % to 30 wt %, from 5 wt % to 25 wt %, from 5 wt % to 20 wt %, from 5 wt % to 15 wt %, from 5 wt % to 10 wt %, from 10 wt % to 30 wt %, from 10 wt % to 25 wt %, from 1.0 wt % to 20 wt %, from 1.0 wt % to 15 wt %, from 15 wt % to 30 wt %, from 15 wt % to 25 wt %, from 15 wt % to 20 wt %, from 20 wt % to 30 wt %, from 20 wt % to 25 wt % or from 25 wt % to 30 wt % of aromatic isocyanates having at least two NCO-functional groups.

In an embodiment of the present disclosure, the water phase component comprises water in amount of at least 3 times, at least 4 times or at least 5 times the total weight of the oil phase component. And the amine compounds having at least two NH-functional groups are used in a mole ratio of NH— to NCO— is from 0.5:1 to 3:1, from 0.5:1 to 2:1, from 0.5:1 to 1:1, from 0.5:1 to 0.7:1, from 0.7:1 to 3:1, from 0.7:1 to 2:1, from 0.7:1 to 1:1, from 1:1 to 3:1, from 1:1 to 2:1 or from 2:1 to 3:1.

In an embodiment of the present disclosure, the phase change materials may comprise organic PCMs or eutectic PCMs. Examples of the phase change materials comprise paraffin hydrocarbons (e.g., C14-C45 paraffin hydrocarbons, e.g., paraffin wax, C14, C18, C22-C45 hydrocarbons, e.g., tetradecane, pentadecane, hexadecane, heptadecane, octadecane), carboxylic acid esters (e.g., fatty acid ester, methyl laurate, ethyl laurate, methyl stearate, ethyl stearate, methyl behenate and ethyl behenate), carboxylic acid (e.g., fatty acids, capric acid, lauric acid, tetradecanoic acid, pentadecanoic acid, hexadecanoic acid, octadecanoic acid), polyalcohols (e.g., polyethylene glycol (PEG)) and etc.

In an embodiment of the present disclosure, the aliphatic isocyanates having at least two NCO-functional groups include aliphatic diisocyanates, as well as dimers and trimers thereof, such as, for example, C2-C8 alkylene diisocyanates, such as tetramethylene diisocyanate and hexamethylene diisocyanate (HDI), 1,12-dodecane diisocyanate, 2,2,4-trimethyl-hexamethylene diisocyanate, 2,4,4-trimethyl-hexamethylene diisocyanate, 2-methyl-1,5-pentamethylene diisocyanate; alicyclic diisocyanates, as well as dimers and trimers thereof, such as, for example, isophorone diisocyanate (IPDI) and dicyclohexyl methane diisocyanate (HMDI), 1,4-cyclohexane diisocyanate, and 1,3-bis-(isocyanatomethyl)cyclohexane; aromatic diisocyanates, as well as dimers and trimers thereof, such as, for example, toluene diisocyanate (TDI), and diphenyl methane diisocyanate (MDI). Preferably, the aliphatic isocyanates are hexamethylene diisocyanate homopolymers, hexamethylene diisocyanate adducts, isophorone diisocyanate homopolymers, isophorone diisocyanate adducts, or mixtures thereof. Most preferably, the aliphatic isocyanates having at least two NCO-functional groups are selected from the group consisting of methylene bis(cyclohexyl isocyanate) (HMDI), hexamethylene-diisocyanate (HDI), tetramethylene-diisocyanate, cyclohexane-diisocyanate, hexahydrotoluene diisocyanate, isophorone diisocyanate (IPDI) and any mixtures thereof.

In an embodiment of the present disclosure, the aromatic isocyanate compound is a C₆-C₁₅ aromatic isocyanate compound having at least two isocyanate (NCO—) groups. The C₆-C₁₅ aromatic isocyanate compound can be selected from the group consisting of diphenylmethanediisocyanate (MDI), toluene diisocyanate (TDI), naphthalene diisocyanate (NDI), phenylene diisocyanate, any isomers thereof and any combinations thereof. The isomers of MDI comprise 4,4′-MDI, 2,4′-MDI, 2,2′-MDI, etc.; the isomers of TDI comprise 2,3-TDI, 2,4-TDI, 2,5-TDI, 2,6-TDI, 3,4-TDI, 3,5-TDI, etc.; the isomers of NDI comprise 1,5-NDI, 1,2-NDI, 1,3-NDI, 1,4-NDI, 1,6-NDI, 1,7-NDI, 1,8-NDI, 2,3-NDI, 2,6-NDI, 2,7-NDI, etc; the isomers of phenylene diisocyanate comprise 1,2-phenylene diisocyanate, 1,3-phenylene diisocyanate, 1,4-phenylene diisocyanate, etc.; and the aromatic isocyanate compound may comprise any one or more of the above indicated isomers. According to an embodiment of the present disclosure, the aromatic isocyanate compound is MDI, such as a mixture of 4,4′-MDI and 2,4′-MDI, particularly speaking, a mixture of 50-99 wt % of 4,4′-MIDI and 1 to 50 wt % of 2,4′-MDI, or a mixture of 98 wt % of 4,4′-MDI and 2 wt % of 2,4′-MDI. Preferably, the aromatic isocyanate compounds are selected from the group consisting of polymethylene polyphenyl isocyanate, diphenylmethanediisocyanate (MDI), toluene diisocyanate (TDI), naphthalene diisocyanate (NDI), phenylene diisocyanate, and any combinations thereof.

In an embodiment of the present disclosure, the amine compounds are water soluble and have at least two NH-functional groups, include an aromatic polyamine, in which the primary amino groups are bonded directly to a carbon atom of an aromatic ring. Examples of such aromatic polyamines include 2,4- and/or 2,6-toluene diamine (TDA), 4,4′-, 2,4′- and 2,2′-diphenyl methane diamine (MDA) or a mixture of any two or more thereof. The water soluble amine compounds having at least two NH-functional groups may include a cycloaliphatic polyamine such as hydrogenated MDA, 1-methyl-2,4-diaminocyclohexane, 1-methyl-2,6-diaminocyclohexane and the like. The amine compounds are water soluble and have at least two NH-functional groups, which may include an aliphatic polyamine such as tetramethylene-1,4-diamine, hexamethylene-1,6-diamine, trimethylhexane diamine, tetramethylhexane diamine, isophorone diamine, 1,3-and/or 1,4-bis(aminomethyl)cyclohexane and 2,4- or 2,6-diamine-1-methylecyclohexane. Preferably, the amine compounds are selected from the group consisting of diethylenetriamine (DETA), triethylenetetramine, tetraethylenepentamine, pentaethylenehexamine, ethylenediamine (EDA), propylene diamine and triethylenediamine, 2,4- and/or 2,6-toluene diamine (TDA), 4,4′-, 2,4′- and 2,2′-diphenyl methane diamine (MDA), 1-methyl-2,4-diaminocyclohexane, 1-methyl-2,6-diaminocyclohexane, tetramethylene-1,4-diamine, hexamethylene-1,6-diamine, trimethylhexane diamine, tetramethylhexane diamine, isophorone diamine, 1,3- and/or 1,4-bis(aminomethyl)cyclohexane and 2,4- or 2,6-diamine-1-methylecyclohexane, and any combinations thereof.

In an embodiment of the present disclosure, the oil phase component further comprises, based on the total weight of the oil phase component, from 5 wt % to 25 wt %, from 5 wt % to 20 wt %, from 5 wt % to 15 wt %, from 5 wt % to 10 wt %, from 10 wt % to 25 wt %, from 10 wt % to 20 wt %, from 10 wt % to 15 wt %, from 15 wt % to 25 wt %, from 15 wt % to 20 wt % or from 20 wt % to 25 wt % of inorganic fillers. Exemplary inorganic fillers include, but are not limited to, natural calcium carbonates, including chalks, calcites and marbles, synthetic carbonates, salts of magnesium and calcium, dolomites, magnesium carbonate, zinc carbonate, lime, magnesia, barium sulphate, barite, calcium sulphate, silica, magnesium silicates, talc, wollastonite, clays and aluminum silicates, kaolins, mica, oxides or hydroxides of metals or alkaline earths, magnesium hydroxide, iron oxides, zinc oxide, glass or carbon fiber or powder, or powder or mixtures of these compounds. Preferably, the inorganic fillers are selected from the group consisting of CaCO₃, talc, mica, SiO₂, TiO₂, Kaolin, coal gangue powders, sepiolite powders, attapulgite powders, montmorillonite, and any combinations thereof.

In an embodiment of the present disclosure, it is not necessary to add surfactants into the composition, so there is no emulsification process. The amine compounds as hardener are firstly added and dissolved in the water phase. The oil phase component is then added in the water phase component. During the addition, the isocyanates in the oil phase components will react with the hardener quickly to form a thin skin to maintain the microcapsule shapes. Oil phase dispersing and shell forming occur almost at the same time. The process is straightforward and robust. The composition for preparing microencapsulated phase change materials is substantially free of any surfactants (e.g., sulphate surfactants, sulphonate surfactants, nonionic surfactants and etc.), stabilizers, organic solvents and emulsifiers (e.g., sodium salt of styrene maleic anhydride copolymer, sodium dodecylbenzene sulfonate, alkylphenol polyoxyethylene ether (OP-10) and etc). In general, the surfactants include anionic surfactant, cationic surfactant, amphoteric surfactant or non-ionic surfactant, which include sulfates of ethoxylated phenols such as poly(oxy-1,2-ethanediyl) α-sulfo-@ (nonylphenoxy) salt; alkali metal fatty acid salts such as alkali metal oleates and stearates; alkali metal C₁₂-C₁₆ alkyl sulfates such as alkali metal lauryl sulfates; amine C₁₂-C₁₆ alkyl sulfates such as amine lauryl sulfates, or triethanolamine lauryl sulfate; alkali metal C₁₂-C₁₆ alkylbenzene sulfonates such as branched and linear sodium dodecylbenzene sulfonates; amine C₁₂-C₁₆ alkyl benzene sulfonates such as triethanolamine dodecylbenzene sulfonate; anionic and nonionic fluorocarbon emulsifiers such as fluorinated C₄-C₁₆ alkyl esters and alkali metal C₄-C₁₆ perfluoroalkyl sulfonates; organosilicon emulsifiers such as modified polydimethylsiloxanes.

In an embodiment of the present disclosure, the microcapsule structure comprises one or a combination of a core-shell structure, a single shell structure, a multi-shell structure, a single cavity-single core structure, a single cavity-multi-core structure, a multi cavity-multi core structure, a porous structure, a skeleton structure and a three-dimensional network structure.

In the present disclosure, a typical composition for preparing microencapsulated phase change materials, wherein the composition comprises an oil phase component and a water phase component;
(1) the oil phase component comprises, based on the total weight of the oil phase component:
   from 40 wt % to 99 wt % of paraffin wax;
   from 0.5 wt % to 30 wt % of isophorone diisocyanate (IPDI) and/or dicyclohexylmethane-4,4′-diisocyanate (HMDI);
   from 0.5 wt % to 30 wt % of polymethylene polyphenyl isocyanate; and
   from 5 wt % to 25 wt % of CaCO₃ and/or talc;
(2) the water phase component comprises:
   water in amount of at least 3 times the total weight of the oil phase component, and
   diethylenetriamine (DETA), wherein the mole ratio of NH— to NCO— is from 0.5:1 to 3:1.

In an embodiment of the present disclosure, the method for preparing microencapsulated phase change materials comprising:
(1) blending a mixture of aliphatic isocyanates having at least two NCO-functional groups and aromatic isocyanates having at least two NCO-functional groups with phase change materials, to form the oil phase component;
(2) dissolving amine compounds having at least two NH-functional groups in water to form a water phase component; and
(3) under stirring, adding the oil phase component into the water phase component to form a dispersion of microencapsulated phase change materials.

In a further embodiment of the present disclosure, step (1) further comprises blending the mixture of aliphatic isocyanates having at least two NCO-functional groups and aromatic isocyanates having at least two NCO-functional groups, and phase change materials with inorganic fillers. In an alternative embodiment of the present disclosure, step (3) further comprises adding inorganic fillers, separately or with the oil phase component, into the water phase component.

In a further embodiment of the present disclosure, the method for preparing microencapsulated phase change materials further comprises, after step (3), a step (4) of filtering the dispersion to provide microencapsulated phase change material powders, which step (4) also produces a filtrate.

In a further embodiment of the present disclosure, the method for preparing microencapsulated phase change materials further comprises, after step (4), recycling the filtrate to step (3).

In the present disclosure, a typical method for preparing microencapsulated phase change materials comprises:
1) blending a mixture of aliphatic isocyanates having at least two NCO-functional groups and aromatic isocyanates having at least two NCO-functional groups with paraffin wax and inorganic fillers (as an anti-caking agent, e.g., CaCO₃ and/or Talc, to provide oil phase;
2) dissolving amine compounds having at least two NH-functional groups (as a hardener) in water, to provide water phase;
3) pouring the oil phase into water phase under stirring, and in an alternative manner, no surfactants, colloidal stabilizers and internal stabilizers (such as, DMPA) are used;
4) curing the mixture obtained in 3) for several hours (e.g., 8 hours) to provide a microcapsule dispersion;
5) filtering the dispersion to form microcapsule powders and a filtrate; and
6) recycling the filtrate to 3) for the polymerization.

The present disclosure provides a feasible microencapsulation method to obtain organic PCM microcapsules. This method has the following benefits:
a) Robust and efficiency process;
b) No solvents or surfactants used;
c) Filtrate is recyclable; and
d) Thickness of shell is controllable to balance cost and anti-leakage

### EXAMPLES

Some embodiments of the invention will now be described in the following examples, wherein all parts and percentages are by weight unless otherwise specified.

The information of the raw materials used in the examples is listed in the following Table 1:

TABLE 1
Raw materials used in the examples

| Raw | | |
|---|---|---|
| materials/ | | |
| Function | Ingredients | Supplier |
| Wax, as PCM | OP25E, melting point 28° C. | Hangzhou Ruhr New Material |
| | (tested by differential scanning | Technology Co., Ltd. |
| | calorimetry (DSC) Calorimeter) | |
| | OP28E, melting point 32° C. | |
| | (tested by DSC) | |
| Isocyanate | Isophorone diisocyanate (IPDI) | Sinopharm Chemical Reagent Co., |
| | dicyclohexylmethane-4,4′- | Ltd |
| | diisocyanate (HMDI) | |
| | PAPI ™ 27 Polymeric MDI (PAPI | The Dow Chemical Company |
| | 27) | |
| Filler | CaCO₃ 1200 mesh (CC-1200) | Local supplier |
| | Talc powder 800 mesh (Talcum- | Local supplier |
| | 800) | |
| | Mica powder 800 mesh | Local supplier |
| Hardener | Diethylenetriamine (DETA) | The Dow Chemical Company |

### Inventive Examples 1-5 and Comparative Examples 1-4

In the following Inventive Examples (IE) 1-5 and Comparative Examples (CE) 1-4, the microencapsulated phase change materials were prepared according to the composition and process described in Table 2.

### A. The Preparation of Oil Phase

In IE 1-4 and CE 1-4, the wax was heated to ~50° C. to provide a hot liquid wax. The aliphatic and aromatic isocyanate mixtures as well as filler (if any) were added into the hot liquid wax according to the composition described in Table 2.

In IE 5, the wax was heated to ~50° C. to provide a hot liquid wax. The aliphatic and aromatic isocyanate mixtures were added into the hot liquid wax according to the composition described in Table 2.

### B. The Preparation of Water Phase

In IE 1-5 and CE 1-4, the water was heated to ~50° C., and then a hardener was added according to the composition described in Table 2.

### C. The Mixing of the Oil Phase and Water Phase

In IE 1-5 and CE 1-4, the hot oil phase was poured into the water phase under stirring at ~500 rpm.

### D. The Curing Via Interfacial Polymerization

In IE 1-4 and CE 1-4, the aliphatic and aromatic isocyanate mixture was cured with hardener via interfacial polymerization at ~50° C. for 6 hours, to provide a dispersion of microencapsulated phase change materials.

In IE 5, the aliphatic and aromatic isocyanate mixture was cured with hardener via interfacial polymerization at ~50° C. for 6 hours, to provide a dispersion of microencapsulated phase change materials. After 6 hours interfacial polymerization, 10 g mica powders in 800 mesh were added.

### E. The Filtering of the Dispersion

The dispersion of microencapsulated phase change materials (IE 1-4) or the microcapsule agglomeration (CE 3-4) was filtered to provide microcapsule powders.

TABLE 2
Composition and process used in the examples

| | Oil phase | | | | |
|---|---|---|---|---|---|
| | | Wax:isocyante | Aliphatic:aromatic | | |
| | Composition | mixture | isocyanate | Water phase | Results |
| Comparative | 100 g OP25E, | 8:1 | 2:3 | 600 g H₂O | Microcapsules |
| example 1 | 5 g IPDI, | | | | not obtained, but |
| (CE 1) | 7.5 g PAPI 27, | | | | a thick system. |
| | 20 g CC-1200 | | | | |
| Comparative | 100 g OP25E, | 8:1 | 2:3 | 3.6 g DETA, | Microcapsules |
| example 2 | 5 g IPDI, | | | 600 g H₂O | obtained, but the |
| (CE 2) | 7.5 g PAPI 27 | | | | microcapsules |
| | | | | | too weak to be |
| | | | | | filtered. |
| Comparative | 100 g OP25E, | 8:1 | 1:0 | 3.6 g DETA, | Microcapsules |
| example 3 | 12.5 g IPDI, | | | 600 g H₂O | agglomeration |
| (CE 3) | 20 g CC-1200 | | | | obtained. |
| Comparative | 100 g OP25E, | 8:1 | 0:1 | 3.6 g DETA, | Microcapsules |
| example 4 | 12.5 g PAPI 27, | | | 600 g H₂O | agglomeration |
| (CE 4) | 20 g CC-1200 | | | | obtained. |
| Inventive | 100 g OP25E, | 8:1 | 2:3 | 3.6 g DETA, | Microcapsules |
| example 1 | 5 g IPDI, | | | 600 g H₂O | obtained and |
| (IE 1) | 7.5 g PAPI 27, | | | | able to be |
| | 20 g CC-1200 | | | | filtered. |
| Inventive | 100 g OP25E, | 8:1 | 15:85 | 3.6 g DETA, | Microcapsules |
| example 2 | 1.9 g IPDI, | | | 600 g H₂O | obtained and |
| (IE 2) | 10.6 g PAPI 27, | | | | able to be |
| | 20 g Talcum-800 | | | | filtered. |
| Inventive | 100 g OP28E, | 8:1 | 1:1 | 3.6 g DETA, | Microcapsules |
| example 3 | 6.25 g HMDI, | | | 600 g H₂O | obtained and |
| (IE 3) | 6.25 g PAPI 27, | | | | able to be |
| | 20 g CC-1200 | | | | filtered. |
| Inventive | 100 g OP25E, | 8:1 | 2:3 | 3.6 g DETA, | Microcapsules |
| example 4 | 5 g IPDI, | | | 300 g filtrate of | obtained and |
| (IE 4) | 7.5 g PAPI 27, | | | IE 1, | able to be |
| | 20 g CC-1200 | | | 300 g filtrate of | filtered. |
| | | | | IE 2 | |
| Inventive | 100 g OP25E, | 8:1 | 1:1 | 3.6 g DETA, | Microcapsules |
| example 5 | 6.25 g IPDI, | | | 600 g H₂O; | obtained and |
| (IE 5) | 6.25 g PAPI 27 | | | After 6 hours | able to be |
| | | | | reaction, 10 g | filtered. |
| | | | | mica powders | |
| | | | | with 800mesh | |
| | | | | size were | |
| | | | | added. | |

### Testing and Evaluation

The morphology of microencapsulated phase change materials obtained in IE 1-5 and CE 1-4 was investigated with an optical microscope. In IE 1-5 and CE 1-4, a drop of the PCM dispersion after curing was taken to place on a glass slide. Then the dispersion drop was dried at room temperature before placed under optical microscope for observing.

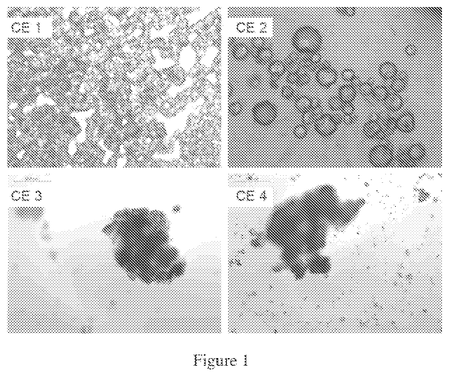

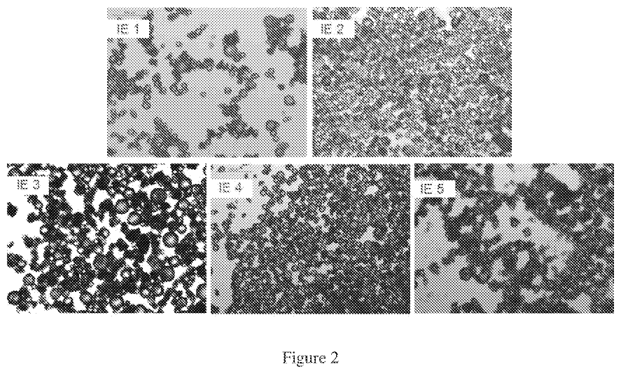

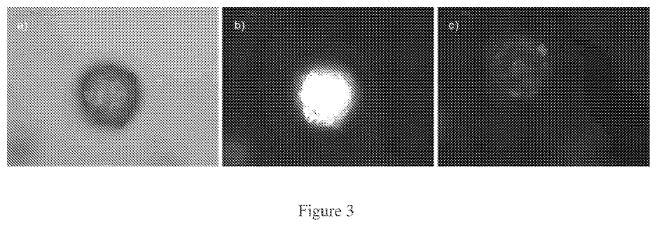

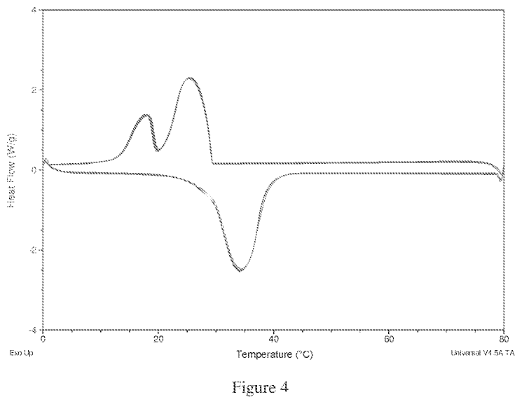

FIG. 1 shows optical microscope pictures of comparative examples CE 1-4. FIG. 2 shows optical microscope pictures of inventive examples IE 1-5. FIG. 3(a) shows optical microscope picture at the room temperature of IE 1. FIG. 3(b) shows polarized microscope picture at the room temperature of IE 1. FIG. 3(c) shows polarized microscope picture at 50° C. (c) of IE 1. FIG. 4 shows 20 solidification-melting cycles DSC curves.

Comparing CE 1 in FIG. 1 with IE 1 in FIG. 2, it is found that if the water phase does not contain amine hardener, the microcapsule cannot be obtained. The isocyanate mixture in CE 1 was reacted with water, but the reaction speed is not fast enough to form a solid shell to protect the microcapsule, even though the temperature rises up to ~50° C. The amine in the water phase is an essential component to react with the isocyanates immediately to form the solid shell when the oil phase was dispersed in the water phase.

In case that the oil phase did not contain any fillers (CE 2 in FIG. 1), microcapsules can also be formed. However, the dispersion becomes thick after the reaction, which means the polymers from the reactions between isocyanate and amine or water in the water phase make the dispersion thickened. Furthermore, the microcapsules obtained are not able to be filtered due to their weak shell. The inorganic fillers as added play important roles not only in helping the sedimentation of polyurea polymers onto the surfaces of microcapsules but also in preventing caking of filtered microcapsules. Different kinds of inorganic fillers can be used, e.g. CaCO₃, mica powder, talcum powder, etc.

Aliphatic isocyanates, such as IPDI, HMDI and HDI, are miscible with wax liquid, while aromatic isocyanates usually have relatively poor solubility in wax liquid. Therefore, a mixture of aliphatic and aromatic isocyanates was used to balance the solubility, reaction speed and crosslinking density. Microcapsules were obtained with these compositions and shown in FIG. 2. The sizes of microcapsules are in the range of 1 to 200 mm.

IPDI was used to make microcapsules. The morphology of the product is shown in CE 3 of FIG. 1: only microcapsule agglomeration can be obtained. The reason is probably that the formed IPDI-DETA prepolymers, which were hydrophilic, were diffused in the water phase to agglomerate micro droplets together. PAPI 27 was also used with the morphology of the product as shown in CE 4 of FIG. 1. Due to its poor solubility in wax liquid and too fast reaction speed, microcapsule agglomeration also occurred.

IE 1-3 in FIG. 2 demonstrates that:
the mixture of aliphatic isocyanate and aromatic isocyanate can well balance the solubility and the reaction speed to produce microcapsules rather than microcapsule agglomeration (IE 1-3 in FIG. 2 VS CE 3-4 in FIG. 1);
the amine hardener in the water phase is an essential component (IE 1-3 in FIG. 2 VS CE 1 in FIG. 1);
with the help and reinforcement of inorganic fillers, the microcapsules can be filtered to form powders or slurry (IE 1-3 in FIG. 2 VS CE 2 in FIG. 1);
different kinds of fillers can be used (IE 1 in FIG. 2 VS IE 2 in FIG. 1).
PCMs with different melting points can be used (IE 1 and IE 2 in FIG. 2 VS IE 3 in FIG. 1).

As shown in IE 4 of FIG. 2, the filtrate can be recycled to use in the water phase, such that the inventive method of preparing microencapsulated PCMs is environmentally friendly. As shown in IE 5, the filler anti-cake aids could be added after the reaction, which may provide more latitude in the manufacturing process.

The microcapsules as obtained are able to achieve good solidification-melting stability, as shown in FIG. 3. FIG. 3(a) shows the optical microscope picture of IE 1 of FIG. 2 at room temperature. When the wax is in a crystal phase, it shows a bright crystal domain under the polarized microscope, as shown in FIG. 3(b). When the wax in the microcapsules melts after heated, the bright crystal domain disappears, as shown in FIG. 3c. The stability is also proved by DSC testing. After 20 cycles of heating and cooling of the microcapsules as shown in IE 3 of FIG. 2, no latent heat drop occurs, as shown in FIG. 4.

1. A composition for preparing microencapsulated phase change materials, wherein the composition comprises an oil phase component and a water phase component;
(1) the oil phase component comprises, based on the total weight of the oil phase component:
from 40 wt % to 99 wt % of phase change materials;
from 0.5 wt % to 30 wt % of aliphatic isocyanates having at least two NCO-functional groups; and
from 0.5 wt % to 30 wt % of aromatic isocyanates having at least two NCO-functional groups;
(2) the water phase component comprises:
water in amount of at least 3 times the total weight of the oil phase component, and
water soluble amine compounds having at least two NH-functional groups, wherein the mole ratio of NH— to NCO— is from 0.5:1 to 3:1.

2. The composition according to claim 1, wherein the oil phase component comprises, based on the total weight of the oil phase component:
from 50 wt % to 90 wt % of phase change materials;
from 5 wt % to 25 wt % of aliphatic isocyanates having at least two NCO-functional groups; and
from 5 wt % to 25 wt % of aromatic isocyanates having at least two NCO-functional groups.

3. The composition according to claim 1, wherein the water phase component comprises:
water, in amount of at least 4 times the total weight of the oil phase component and
amine compounds having at least two NH-functional groups, wherein the mole ratio of NH— to NCO— is from 0.7:1 to 2:1.

4. The composition according to claim 1, wherein the aliphatic isocyanates are selected from the group consisting of methylene-bis(cyclohexyl isocyanate) (HMDI), hexamethylene-diisocyanate (HDI), tetramethylene-diisocyanate, cyclohexane-diisocyanate, hexahydrotoluene diisocyanate, isophorone diisocyanate (IPDI) and any mixtures thereof;
the aromatic isocyanate compounds are selected from the group consisting of polymethylene polyphenyl isocyanate, diphenylmethanediisocyanate (MDI), toluene diisocyanate (TDI), naphthalene diisocyanate (NDI), phenylene diisocyanate, and any combinations thereof; and/or
the amine compounds are selected from the group consisting of diethylenetriamine (DETA), triethylenetetramine, tetraethylenepentamine, pentaethylenehexamine, ethylenediamine (EDA), propylene diamine and triethylenediamine, 2,4- and/or 2,6-toluene diamine (TDA), 4,4′-, 2,4′- and 2,2′-diphenyl methane diamine (MDA), 1-methyl-2,4-diaminocyclohexane, 1-methyl-2,6-diaminocyclohexane, tetramethylene-1,4-diamine, hexamethylene-1,6-diamine, trimethylhexane diamine, tetramethylhexane diamine, isophorone diamine, 1,3- and/or 1,4-bis(aminomethyl)cyclohexane and 2,4- or 2,6-diamine-1-methylecyclohexane, and any combinations thereof.

5. The composition of claim 1, wherein the oil phase component further comprises, based on the total weight of the oil phase component, from 5 wt % to 25 wt % of inorganic fillers; and the inorganic fillers are selected from the group consisting of CaCO₃, talc, mica, SiO₂, TiO₂, Kaolin, coal gangue powders, sepiolite powders, attapulgite powders, montmorillonite, and any combinations thereof.

6. The composition of claim 1, wherein the composition is free of any surfactants, stabilizers, organic solvents and emulsifiers.

7. A method for preparing microencapsulated phase change materials comprising:
(1) blending a mixture of aliphatic isocyanates having at least two NCO-functional groups and aromatic isocyanates having at least two NCO-functional groups with phase change materials, to form an oil phase component, and the oil phase component comprises, based on the total weight of the oil phase component:
from 40 wt % to 99 wt % of phase change materials;
from 0.5 wt % to 30 wt % of aliphatic isocyanates having at least two NCO-functional groups; and
from 0.5 wt % to 30 wt % of aromatic isocyanates having at least two NCO-functional groups;
(2) dissolving amine compounds having at least two NH-functional groups in water to form a water phase component and the water phase component comprises:
water in amount of at least 3 times the total weight of the oil phase component, and
amine compounds having at least two NH-functional groups, wherein the mole ratio of NH— to NCO— is from 0.5:1 to 3:1; and
(3) under stirring, adding the oil phase component into the water phase component to form a dispersion of microencapsulated phase change materials.

8. The method according to claim 7, wherein the oil phase component comprises, based on the total weight of the oil phase component:
from 50 wt % to 90 wt % of phase change materials;
from 5 wt % to 25 wt % of aliphatic isocyanates having at least two NCO-functional groups; and
from 5 wt % to 25 wt % of aromatic isocyanates having at least two NCO-functional groups.

9. The method according to claim 7, wherein the water phase component comprises:
water, in amount of at least 4 times the total weight of the oil phase component and
amine compounds having at least two NH-functional groups, wherein the mole ratio of NH— to NCO— is from 0.7:1 to 2:1.

10. The method of claim 7, wherein the aliphatic isocyanates are selected from the group consisting of methylenebis(cyclohexyl isocyanate) (HMDI), hexamethylene-diisocyanate (HDI), tetramethylene-diisocyanate, cyclohexane-diisocyanate, hexahydrotoluene diisocyanate, isophorone diisocyanate (IPDI) and any mixtures thereof;
the aromatic isocyanate compounds are selected from the group consisting of polymethylene polyphenyl isocyanate, diphenylmethanediisocyanate (MDI), toluene diisocyanate (TDI), naphthalene diisocyanate (NDI), phenylene diisocyanate, and any combinations thereof; and/or
the amine compounds are selected from the group consisting of diethylenetriamine (DETA), triethylenetetramine, tetraethylenepentamine, pentaethylenehexamine, ethylenediamine (EDA), propylene diamine and triethylenediamine, 2,4- and/or 2,6-toluene diamine (TDA), 4,4′-, 2,4′- and 2,2′-diphenyl methane diamine (MDA), 1-methyl-2,4-diaminocyclohexane, 1-methyl-2,6-diaminocyclohexane, tetramethylene-1,4-diamine, hexamethylene-1,6-diamine, trimethylhexane diamine, tetramethylhexane diamine, isophorone diamine, 1,3- and/or 1,4-bis(aminomethyl)cyclohexane and 2,4- or 2,6-diamine-1-methylecyclohexane, and any combinations thereof.

11. The method of claim 7, wherein step (1) further comprises blending the mixture, phase change materials with inorganic fillers, such that the oil phase component further comprises, based on the total weight of the oil phase component, from 5 wt % to 25 wt % of inorganic fillers.

12. The method of claim 7, wherein step (3) further comprises adding inorganic fillers in amount of from 5 wt % to 25 wt %, based on the total weight of the oil phase component; and the inorganic fillers are selected from the group consisting of CaCO₃, talc, mica, SiO₂, TiO₂, Kaolin, coal gangue powders, sepiolite powders, attapulgite powders, montmorillonite, and any combinations thereof.

13. The method of claim 7, wherein the method is free of inclusion of any surfactants, stabilizers, organic solvents and emulsifiers.

14. The method of claim 7, wherein the method further comprises, after step (3), a step (4) of filtering the dispersion to provide microencapsulated phase change material powders, which step (4) also produces a filtrate.

15. The method according to claim 14, wherein the method further comprises, after step (4), recycling the filtrate to step (3).
